(19) United States
(12) Patent Application Publication
(10) Pub. No.: US 2014/0093331 A1
(43) Pub. Date: Apr. 3, 2014

(54) Ballistic Resistant Fasterner

(71) Applicant: Stephen L. McGrade, Beaumont, TX (US)

(72) Inventor: Stephen L. McGrade, Beaumont, TX (US)

(21) Appl. No.: 13/848,590

(22) Filed: Mar. 21, 2013

Related U.S. Application Data
(63) Continuation of application No. 12/495,317, filed on Jun. 30, 2009, now abandoned.
Application No. 12/495,317 is a continuation-in-part of application No. 11/974,324, filed on Oct. 12, 2007, now abandoned.
Application No. 11/974,324 is a continuation-in-part of application No. 11/447,000, filed on Jun. 5, 2006, now abandoned.
(60) Provisional application No. 60/757,651, filed on Jan. 10, 2006.

(51) Int. Cl. F41H 1/04; F16B 19/00

(52) U.S. Cl. CPC F41H 1/04; F16B 19/00
USPC 411/500

(57) ABSTRACT

A ballistic resistant fastening member includes a bolt head that has a generally circular shape. The bolt head further includes a top surface and an underside surface disposed opposite the top surface. The fastening member further includes a shaft extending from the underside surface of the bolt head and having a minimum length of 0.40 inches. The shaft further includes a top having an outwardly tapered radius, wherein the top is mechanically disposed with the underside surface and a bottom end distal from the top. The fastening member further includes a bore extending from the bottom end of the shaft into the shaft. The fastening member further includes a slot disposed on the top surface of the bolt head, wherein the length of the slot is less than the diameter of the bolt head.

### CROSS REFERENCE TO RELATED APPLICATIONS

The present application is a continuation of U.S. Non-Provisional application Ser. No. 12/495,317 filed Jun. 30, 2009, still pending, which is a continuation-in-part of U.S. Non-Provisional application Ser. No. 11/974,324 filed Oct. 12, 2007, now abandoned, which is a continuation-in-part of U.S. Non-Provisional application Ser. No. 11/447,000 filed Jun. 5, 2006, now abandoned, which claims the benefit of prior U.S. Provisional Application No. 60/757,651, filed Jan. 10, 2006.

### FIELD

The present invention relates generally to fasteners, and in specific though non-limiting embodiment, to a ballistic resistant bolt used to secure straps to a ballistic resistant helmet.

### BACKGROUND

Military combat helmets are currently made out of Kevlar® brand material, an aramid fibrous material made from a nylon-like polymer, for example, poly-para-phenylene terephthalamide. Such helmets are designed to be ballistic resistant. A consistent, unsolvable problem has been the design of a ballistic resistant bolt that extends from the outside of the helmet to the inside of the helmet in order to secure the helmet's straps.

Although fastener systems intended to be used in conjunction with ballistic proof and armored panels are known, for example, U.S. Pat. Nos. 5,438,908 and 5,600,084, such systems lack fasteners wherein the bolt itself is ballistic resistant. U.S. Pat. No. 6,854,921, for example, discloses and claims a ballistic cap nut, which is distinguishable from the ballistic resistant bolt disclosed and claimed herein.

### SUMMARY

Embodiments include a ballistic resistant fastening member that comprises a bolt head that has a generally circular shape. The bolt head further comprises a top surface and an underside surface disposed opposite the top surface. Some embodiments of the bolt head further comprise a side surface disposed along the edge of the top surface and along the edge of the underside surface. Typical embodiments of the side surface have a height of less than about 0.066 inches.

In one embodiment, the ballistic resistant fastening member further comprises a shaft that extends from the underside surface of the bolt head and has a minimum length of 0.40 inches. Further embodiments of the shaft comprise a top having an outwardly tapered radius. In some embodiments, the top is mechanically disposed with the underside surface and a bottom end distal from the top.

The fastening member further comprises a bore that extends from the bottom end of the shaft into the shaft. Some embodiments of the fastening member further comprise a slot disposed on the top surface of the bolt head. Embodiments of the slot have a length less than that of the diameter of the bolt head.

In one embodiment, the bore accommodates 6-32-2B threads. In yet another embodiment, the bore has a diameter between about 50% and about 73% of the diameter of the bottom end of the shaft.

### BRIEF DESCRIPTION OF THE DRAWINGS

FIG. 1 is a top view of a bolt having a single slot disposed within a round bolt head.

FIG. 2 is a side view of a ballistic resistant bolt.

FIG. 3 is a schematic of the application of a plurality of ballistic resistant bolts to a helmet.

FIG. 4 illustrates the simultaneous application of a bolt to a helmet and a chin strap.

### DESCRIPTION OF EMBODIMENT(S)

The description that follows includes exemplary systems, methods, and techniques that embody techniques of the presently inventive subject matter. However, it is understood that the described embodiments may be practiced without these specific details. In other instances, well-known manufacturing equipment, protocols, structures and techniques have not been shown in detail in order to avoid obfuscation in the description.

Embodiments of the inventive subject matter utilize a ballistic resistant bolt in a fastener system for securing the straps of a security helmet. Embodiments of the bolt's design provide additional protection to the ballistic resistant surface of a military combat helmet. In some embodiments, the uniquely designed bolt extends from the outside of a military combat helmet to the inside of the helmet.

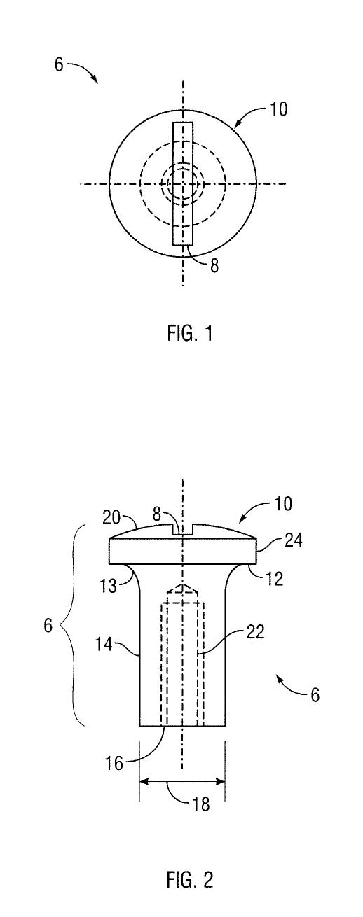

Referring now to FIG. 1, a top view of a ballistic resistant bolt head is illustrated comprising a single slot. In FIG. 1, a ballistic resistant bolt 6 includes a bolt head 10 having a generally circular shape. Typical embodiments include a slot 8 disposed within the round bolt head 10. In some embodiments, slot 8 provides a means for engaging bolt 6. Slot 8 extends in a radial direction from the approximate center of bolt head 10 toward the outer circumference of bolt head 10 in the embodiment depicted in FIG. 1.

FIG. 2 depicts a side view of a ballistic resistant bolt. In FIG. 2, an embodiment of a ballistic resistant bolt 6 includes bolt head 10, a slot 8, an underside surface 12 of bolt head 10, and an elongated shaft 14. Embodiments of bolt head 10 comprise a rounded top surface 20 having a highest point of relief, or apex, approximately at the center of bolt head 10. In one embodiment, the rounded top surface 20 uniformly slopes downward from the apex towards the circumference edge of bolt head 10. In another embodiment, bolt head 10 is further defined by a side surface 24 extending from the circumference edge of bolt head 10 to the underside surface 12. In still another embodiment, slot 8 is disposed within bolt head 10 and extends downward along top surface 20.

In further embodiments, an elongated shaft 14 is attached to bolt head 10 and extends from the underside surface 12 and terminates at an end surface 16. Typical embodiments of the elongated shaft 14 have a minimum length of at least 0.40 inches. The embodiment depicted in FIG. 2 further includes a radius 13 under the bolt head 10 that tapers the head into the elongated shaft 14. In typical embodiments, the radius 13 provides additional support for the bolt head 10 and enhances the durability of the ballistic resistant bolt 6.

In one example embodiment, shaft 14 has a common central axis with an apex of round bolt head 10. In other embodiments, shaft 14 is cylindrical in shape, having a diameter 18 which is typically less than the diameter of bolt head 10. In still further embodiments, a bore, or internal barrel, 22 is disposed within elongated shaft 14 along a central axis of elongated shaft 14. Typical embodiments of internal barrel 22 extend from end surface 16 toward bolt head 10, thereby forming an internal barrel. In many embodiments, at least a portion of the internal barrel 22 comprises internal threads therein.

In one particular embodiment, the shaft 14 comprises a chamfer 15 disposed along the bottom end of shaft 14. In some embodiments, chamfer 15 has an inwardly tapered radius. In still other embodiments, internal barrel 22 extends through the chamfer 15.

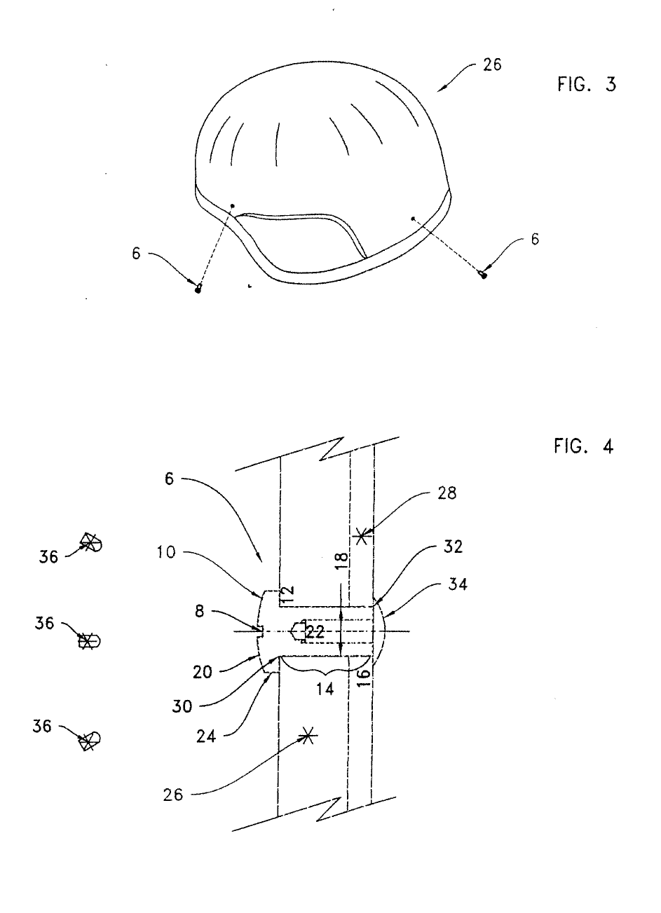

Referring now to FIG. 3, a schematic illustrates the application of a plurality of bolts to a helmet. Embodiments of ballistic resistant bolts 6 are inserted into helmet 26 for use in securing straps to the helmet. In some applications, helmet 26 is made of one or more ballistic resistant materials. In one example embodiment, helmet 26 includes a chinstrap 28 (not shown) secured to helmet 26 via a plurality of bolts 6.

FIG. 4 depicts the application of a bolt to a helmet. In FIG. 4, helmet 26 and chinstrap 28 (shown in cross section for clarity) are secured together. In some embodiments, apertures in helmet 26 and chinstrap 28 allow for the introduction of bolt 6. In further embodiments, a fastening element 34 mates with internal threads of internal barrel 22, thereby securing chinstrap 28 to helmet 26. Thus, the helmet wearer is protected from projectiles 36 approaching bolt head 10 from various angles.

### Bolt Head Diameters

Referring now to the example embodiments depicted in FIGS. 1-4, the surface area of underside surface 12 of bolt head 10 prevents bolt 6 from pushing through the apertures of helmet 26 and/or chinstrap 28. Further, the diameter of embodiments of bolt head 10 is often limited in length so as to preserve ballistic resistance. In some embodiments, an excessive diameter for bolt head 10, in relation to the diameter of shaft 14, increases the ability of shear forces on bolt head 10 relative to shaft 14 (or shear forces on shaft 14 relative to bolt head 10) to cause failure of ballistic resistant bolt 6.

In many embodiments, the ratio of the diameter of bolt head 10 to the diameter of shaft 14 is maintained within a tolerance range between approximately 1.3 to 1 and 2.1 to 1. Preferred embodiments typically comprise a bolt head diameter that prevents aperture-entry failure while concurrently providing resistance to shear failure between the bolt head and shaft. In one preferred though non-limiting embodiment, ratios are maintained within a tolerance range of 1.65 to 1. In further embodiments, the bolt head 10 diameter measures between approximately 0.35 inches and approximately 0.5 inches. In the example embodiment depicted in FIG. 2, the bolt head diameter is approximately 0.438 inches.

The shaft diameter often varies in proportion to the bolt head diameter. In some embodiments, the shaft diameter ranges between approximately 0.228 inches and approximately 0.310 inches. In the example embodiment depicted in FIG. 2, the shaft diameter is approximately 0.230 inches.

### Taper and Side Surface Features

Referring now to the embodiments depicted in FIGS. 1 and 2, the rounded top surface 20 uniformly slopes downward from the apex towards the circumference edge of bolt head 10, terminating in side surface 24. In one example embodiment, side surface 24 extends in a longitudinal direction relative to the axis formed by bolt head 10 and shaft 14, terminating at underside surface 12.

Typical embodiments comprise a side surface 24 to eliminate possible weak points in the bolt head 10 and create desirable ballistic resistant properties. In one specific though non-limiting embodiment, side surface 24 of bolt head 10 is approximately 0.065 inches thick and has an approximate diameter of between 0.35 to 0.5 inches. In typical embodiments, side surface 24 has a thickness of between 0.06 and 0.08.

### Slot 8 Features

Continuing with the example embodiments illustrated in FIGS. 1 and 2, the center of slot 8 is approximately located at the apex of the bolt head 10. In typical embodiments, strength is provided to bolt 6 by restricting the length of slot 8 within a diameter of bolt head 10. In one embodiment, the uniform width of slot 8 is no greater than approximately 0.062 inches. In further embodiments, slot 8 has a depth between 0.028 and 0.040.

In still further embodiments, a sufficient portion of bolt head 10 and/or shaft 14 remains disposed between slot 8 and internal barrel 22 so as to prevent communication between slot 8 and internal barrel 22. In many example embodiments, the exact dimensions of slot 8 can be conformed to specific applications or needs.

### Internal Barrel Features

Referring still to the example embodiments depicted in FIGS. 1 and 2, the internal barrel 22 is of sufficient diameter so as to provide adequate engagement of a screw or second fastening member to shaft 14 of ballistic resistant bolt 6. However, the diameter of embodiments of internal barrel 22 is often limited by the diameter of shaft 14. An excessive diameter for internal barrel 22, in relation to the diameter of shaft 14, increases the ability of shear forces on bolt head 10 relative to shaft 14 (or shear forces on shaft 14 relative to bolt head 10) to cause failure of bolt 6. In one embodiment, the diameter of the internal barrel 22 is maintained within a range of approximately 50% to 73% of the diameter of the shaft 14.

Ratios approximate to the above ratio provide sufficient adequate engagement of a second fastening member to the shaft while concurrently providing sufficient resistance to shear failure between the bolt head and shaft. For shaft diameters between approximately 0.228 inches and 0.310 inches, this represents a barrel diameter sufficient to accommodate 6-32, 8-32, 10-24, or 10-32 threads. In typical embodiments, the diameter of the internal barrel to the diameter of the shaft is preferably maintained within a tolerance range of approximately 55% to approximately 65%. For some embodiments comprising shaft diameters between approximately 0.22 inches and 0.23 inches, the internal barrel 22 diameter is sufficient to accommodate 6-32 threads.

Referring still to the example embodiments depicted in FIGS. 1 and 2, shaft 14 extends from underside surface 12 of bolt head 10 to end surface 16 for a distance of approximately 0.5 inches. In some embodiments, a radius 13, having a length of 0.060 inches, tapers the bolt head 10 into the elongated shaft 14. Typical embodiments of radius 13 range from about 0.055 to 0.065 inches in length and provide additional support for the bolt head 10.

In the embodiment depicted in FIG. 2, the diameter of shaft 14 is 0.230 inches while the length of internal barrel 22 is 0.250 inches and threaded with 6-32-2B threads. In some embodiments, the diameter of shaft 14 ranges from 0.228 inches to 0.310 inches. In other embodiments, the length of internal barrel 22 ranges from about 0.240 inches to about 0.390 inches. In one embodiment, only a portion of internal barrel 22 is threaded, providing a grip area without threads.

### Operations

In typical embodiments, helmet 26 and chinstrap 28 are positioned such that apertures included in each are approximately aligned. In a preferred embodiment, a single bolt 6 extends through both apertures and would be secured in position using fastening element 34. In one embodiment, bolt 6 is adjusted using slot 8. Adjustment can be accomplished with any solid tool or article that is able to fit within slot 8, such as a flat head screwdriver, a token or coin, etc. Thus, the user is not forced to carry a specialized tool in order to adjust bolt 6, thereby reducing weight requirements in the field.

While the inventive subject matter is well adapted for use with helmets, the fastener assembly can also be utilized with little or no modification in virtually any mobile device where security and ballistic resistant properties are important considerations. Additionally, the inventive subject matter may also be implemented in any stationary structure where ballistic resistant is a concern.

### Additional Options

In addition to the embodiments described above, the present ballistic resistant fastener is also capable of serving as a housing for a variety of tracking devices. In one embodiment, a hollowed out portion of the fastener shaft, or alternatively, an extended portion of the shaft, can be equipped with a receiver and/or transmitter and disposed in communication with a global positioning system or another monitoring system. Such embodiments can allow users, such as military, security personnel, etc., employing devices equipped with an embodiment of a fastener to be tracked or located should they become lost or injured. In other embodiments, ballistic resistant fastener can be equipped with infrared and radio frequency applications. In some embodiments, infrared and frequency type applications facilitate communications between users employing devices equipped with an embodiment of a fastener. In other embodiments, the package serves as a scrambler or blocker of other signals that might otherwise be used by a hostile force to locate or track the wearer. In still other embodiments, the claimed fastener houses an illumination means so that the wearer can be equipped with an infrared light or light of another spectrum to assist the visual aspects of a search or patrol mission, for example.

In short, any type of electronics package can be inserted into a void space formed in the fastener, or within or upon an extension of the fastener shaft (or even an annular, washer-like device disposed beneath the head of the fastener), the only functional limitation being that the package housing must conform generally to the existing shape and contours of the ballistic resistant fastener claimed herein.

The foregoing specification is provided for illustrative purposes only, and is not intended to describe all possible aspects of the present invention. Moreover, while the embodiments are described with reference to various implementations and exploitations, it will be understood that these embodiments are illustrative and that the scope of the inventive subject matter is not limited thereby. In general, embodiments of a ballistic resistant bolt used to secure straps to a ballistic resistant helmet as described herein may be implemented using methods, facilities, and devices consistent with any appropriate structural or mechanical systems. Many variations, modifications, additions, and improvements are also possible without departing from the spirit or scope of the invention as claimed.

For example, plural instances may be provided for components, operations or structures described herein as a single instance. Boundaries between various components, operations and functionality are depicted somewhat arbitrarily, and particular operations are illustrated within the context of specific illustrative configurations. Other allocations of functionality are envisioned and will also fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may also fall within the scope of the inventive subject matter.

What is claimed is:

1. A ballistic resistant fastening member comprising:
a bolt head having a generally circular shape, said bolt head further comprising:
a top surface; and
an underside surface disposed opposite said top surface;
a shaft extending from said underside surface of said bolt head and having a minimum length of 0.40 inches, said shaft further comprising:
a top having an outwardly tapered radius, wherein said top is mechanically disposed with said underside surface; and
a bottom end distal from said top;
a bore extending from said bottom end of said shaft into said shaft.

2. The ballistic resistant fastening member of claim 1, wherein said bolt head further comprises:
a slot disposed on said top surface of said bolt head, wherein a length of said slot is less than a diameter of said bolt head; and
a side surface disposed about the edge of said top surface and about the edge of said underside surface, wherein said side surface has a height less than about 0.066 inches.

3. The ballistic resistant fastening member of claim 1, wherein said shaft further comprises:
a chamfer disposed about said bottom end of said shaft, wherein said chamfer has an inwardly tapered radius, wherein said bore extends through said chamfer.

4. The ballistic resistant fastening member of claim 1, wherein said shaft has a common central axis with said bolt head and said bottom end of said shaft has a diameter of between 0.228 inches and 0.310 inches.

5. The ballistic resistant fastening member of claim 1, wherein said bolt head has a diameter of between about 0.35 inches and about 0.5 inches.

6. The ballistic resistant fastening member of claim 4, wherein said bore has a diameter between about 50% and about 73% of the diameter of said bottom end of said shaft.

7. The ballistic resistant fastening member of claim 1, wherein said top surface is rounded.

8. The ballistic resistant fastening member of claim 2, wherein said slot is a means for rotationally engaging said bolt head.

9. The ballistic resistant fastening member of claim 2, wherein said slot has a uniform width of about 0.062 inches.

10. The ballistic resistant fastening member of claim 2, wherein a portion of said shaft separates said slot and said bore, whereby communication between said slot and said bore is prevented.

11. The ballistic resistant fastening member of claim 2, wherein the depth of said slot is equal to or less than about 0.035 inches.

12. The ballistic resistant fastening member of claim 1, wherein the diameter of said bore is sufficient to accommodate 6-32-2B threads.

13. A ballistic resistant bolt for securing straps to a ballistic resistant helmet, said bolt comprising:
a bolt head having a generally circular shape, said bolt head further comprising:
a top surface;
an underside surface disposed opposite said top surface; and
a side surface disposed about the edge of said top surface and about the edge of said underside surface;
a slot disposed on said top surface of said bolt head, wherein a length of said slot is less than a diameter of said bolt head;
a shaft having extending from said underside surface, said shaft further comprising:
a top having an outwardly tapered radius, wherein said top is mechanically disposed with said underside surface; and
a second end disposed opposite said first end; and
a bore extending from said second end into said shaft.

14. The ballistic resistant bolt of claim 14, wherein said slot is utilized to rotationally engage said ballistic resistant bolt with said ballistic resistant helmet.

15. The ballistic resistant bolt of claim 14, wherein said bore accommodates 6-32-2B threads.

16. The ballistic resistant bolt of claim 14, wherein said straps comprise one or more apertures, wherein said ballistic resistant bolt can pass through said one or more apertures.

17. A ballistic resistant jacket bolt comprising:
a round bolt head sloping uniformly from an apex to a top circumference edge, said bolt head having a diameter of between 0.35 inches and 0.50 inches and having a straight edge of between 0.039 inches and 0.066 inches;
a shaft extending from an underside of said bolt head to an end surface distal from said bolt head with a minimum length of 0.40 inches, said shaft having a common central axis with said bolt head and a diameter of between 0.228 inches and 0.310 inches, said shaft having an outwardly tapered radius; and
an internal threads portion within said shaft extending a distance of approximately 0.25 inches, said internal threads having 6-32-2B threads with an approximate thread depth of 0.375 inches.

18. The ballistic resistant jacket bolt of claim 17, wherein said bolt head contains a slot along a diameter of said bolt head equidistant from an apex of said bolt head and having a length less than a said diameter of said bolt head.
